(19) United States
(12) Patent Application Publication
(10) Pub. No.: US 2025/0111607 A1
(43) Pub. Date: Apr. 3, 2025

(54) REAL TIME IMAGE RENDERING VIA OCTREE BASED NEURAL RADIANCE FIELD

(71) Applicant: 1000786269 ONTARIO INC., Toronto (CA)

(72) Inventors: Yuanming Shu, Toronto (CA); Weiguang Ding, Toronto (CA)

(21) Appl. No.: 18/890,309

(22) Filed: Sep. 19, 2024

Related U.S. Application Data
(60) Provisional application No. 63/587,469, filed on Oct. 3, 2023.

(51) Int. Cl. G06T 17/00; G06T 9/00; G06V 10/44; G06V 10/771

(52) U.S. Cl. CPC G06T 17/005; G06T 9/00; G06V 10/44; G06V 10/771

(57) ABSTRACT

Methods and systems for generating a sparse neural radiance field and for real-time image rendering via the sparse neural radiance field are provided. An example method for generating a sparse neural radiance field involves encoding source images of a scene, decoding feature information for a set of target views based on the encoded source image features, and mapping the decoded feature information for the set of target views to a sparse three-dimensional representation of a scene. An example method for real-time image rendering via a sparse neural radiance field involves determining the parts of the sparse neural radiance field to be used to render the image based on the rendering view, retrieving the appropriate feature information stored in the sparse neural radiance field, and decoding the retrieved feature information into a rendered image.

### BACKGROUND

Novel view synthesis is a task in computer vision that involves generating images of a scene from arbitrary viewpoints based on a sparse collection of source images. A recent advancement in novel view synthesis is the development of neural radiance fields. This approach involves training a deep neural network to model the view-dependent radiance of a scene as a continuous function in three-dimensional space. The trained neural network can generate highly realistic view-dependent images of a scene from arbitrary viewpoints. Applications of novel view synthesis may be found in various domains including three-dimensional scene reconstruction, virtual reality, augmented reality, digital twins, video compression, and more.

### BRIEF DESCRIPTION OF THE DRAWINGS

FIG. 1 is a schematic diagram of an example system for generating a sparse neural radiance field and for real-time image rendering via the sparse neural radiance field.

FIG. 2 is a schematic diagram of an example system for generating a sparse neural radiance field.

FIG. 3 is a schematic diagram that illustrates in greater detail an example encoder and decoder of a system for generating a sparse neural radiance field.

FIG. 4 is a schematic diagram that illustrates an example mapping of multiscale feature information to an octree structure to form an octree-based neural radiance field.

FIG. 5 is a schematic diagram of an example system for mapping feature information to an octree structure in a multiscale fashion, and in accordance with a learned process, to form an octree-based neural radiance field.

FIG. 6 is a schematic diagram that illustrates an example octree cell projection process involved in mapping feature information to an octree structure.

FIG. 7 is a schematic diagram of an example system for real-time image rendering via a sparse neural radiance field.

FIG. 8 is a schematic diagram that illustrates an example of retrieval of multiscale feature information from an octree-based neural radiance field.

FIG. 9A illustrates an example of how the cells of a sparse neural radiance field that are in close proximity to a particular cell can be captured for inclusion in a local attention mechanism of an image rendering process. FIG. 9B illustrates another example of how additional cells in close proximity to a particular cell can be captured.

FIG. 10 is a schematic diagram of another example system for real-time image rendering via an octree-based neural radiance field in accordance with a learned process.

FIG. 11A illustrates the interfering effect that an occlusion may have on an image rendering process using a sparse neural radiance field without the aid of a depth map. FIG. 11B, in contrast, illustrates how the interfering effect of an occlusion on the image rendering process can be overcome with the aid of a depth map.

FIG. 12 is a schematic diagram of an example system for generating a sparse neural radiance field at a centralized server and/or platform and for real-time image rendering via the centralized server and/or platform.

FIG. 13 is a schematic diagram of an example system for generating a sparse neural radiance field at a centralized server and/or platform and for real-time image rendering locally at a user device.

FIG. 14 is a flowchart of an example method for generating a sparse neural radiance field.

FIG. 15 is a flowchart of an example method for real-time image rendering via a sparse neural radiance field.

### DETAILED DESCRIPTION

Significant advancements have been made in the field of novel view synthesis in recent years with the introduction of Neural Radiance Fields (NeRF) (Mildenhall, Ben, et al. “Nerf: Representing scenes as neural radiance fields for view synthesis.” Communications of the ACM 65.1 (2021): 99-106). As originally proposed, the NeRF technique involves overfitting a neural network to a collection of source images depicting an individual scene. Although the resulting neural network can be used to recreate highly realistic novel views of a scene, the training process requires a large number of source images, a long per-scene optimization, and the resulting neural network can only be used to generate views of the scene on which it was trained.

Follow-on works, including Multi-View Stereo NeRF (MVSNeRF) (Chen, Anpei, et al. “MVSNeRF: Fast generalizable radiance field reconstruction from multi-view stereo.” Proceedings of the IEEE/CVF International Conference on Computer Vision. 2021), have achieved generalizability across scenes, with faster optimization time, on fewer input source images. However, the MVSNeRF technique requires applying 3D convolutions to build a 3D neural encoding volume for each scene, which is costly to generate and maintain at scale. Further, MVSNeRF requires ray marching through a 3D neural encoding volume, which is a costly process that precludes real-time image rendering.

An earlier-filed patent application (U.S. patent application Ser. No. 18/769,041, entitled GENERALIZABLE NOVEL VIEW SYNTHESIS GUIDED BY LOCAL ATTENTION MECHANISM (the “'041 Application”)), which is incorporated herein by reference in its entirety, proposes to avoid relying on 3D neural encoding volumes by instead synthesizing novel views based directly on 2D neural features extracted from source images of a scene. The previous disclosure also describes a local attention mechanism as part of the image decoding process that involves generating a depth map for the scene that aids in the image decoding process.

This disclosure extends the previous disclosure provided in the '041 Application by proposing that 2D neural features can be mapped to a sparse three-dimensional representation of a scene to speed up the image decoding process to enable real-time image rendering. In particular, this disclosure proposes to map the 2D neural features that are generated during the course of decoded images to a sparse three-dimensional data structure that captures the surface structure of the scene, such as a voxel grid, octree structure, or other sparse three-dimensional data structure. An octree structure may be particularly well suited to the storage of multiscale feature information for this purpose.

Further, a will be seen below, the structure of the sparse three-dimensional representation of the scene itself can be generated from the same depth maps that were generated to aid in the initial image decoding process. Therefore, after capturing a set of source images of a scene, and after decoding a set of novel views of the scene (with corresponding depth maps), a sparse three-dimensional representation of the scene can be directly generated based on the depth maps (without the need for a separate data source that captures 3D structure such as LiDAR data), and the decoded feature information can be mapped to this data structure (e.g., voxels, octree cells). The result is a sparse neural radiance field that can be used for direct image rendering.

The use of a sparse neural radiance field for image rendering as described in this disclosure provides several advantages. First, the techniques described herein are generalizable across scenes. The image encoding, decoding, depth map generation, feature mapping, and image rendering processes can all be learnable processes that can be trained and implemented on a variety of scenes.

Second, as will be described below, feature information can be mapped to the data structure in a process that involves learned attention mechanisms, which enables the system to learn to store the most appropriate feature information that produces the most accurate rendered images. This can be particularly advantageous for eliminating shadows and for accounting for differences in lighting between source images. This learned process can also involve the generation of depth maps which can aid in overcoming interference caused by occlusions.

Third, the overall process can be trained end-to-end on image loss, without the need for annotated training data that represents the three-dimensional structure of scenes (e.g., LiDAR data). Rather, the three-dimensional structure of a scene can be learned inherently in an unsupervised manner through the image decoding processes that involves the generation of depth maps as an intermediate process.

Finally, a sparse neural radiance field can store detailed feature information near the surfaces of the scene without the need to store detailed feature information throughout the entire volume of the scene. Under this design, images can be rendered based on the feature information stored at or near the surfaces of the scene, without the need for a costly ray marching process that involves accumulating feature information along a projection ray. Storing feature information more densely near the surface structure of the scene speeds up the image rendering process to a point that enables real-time image rendering.

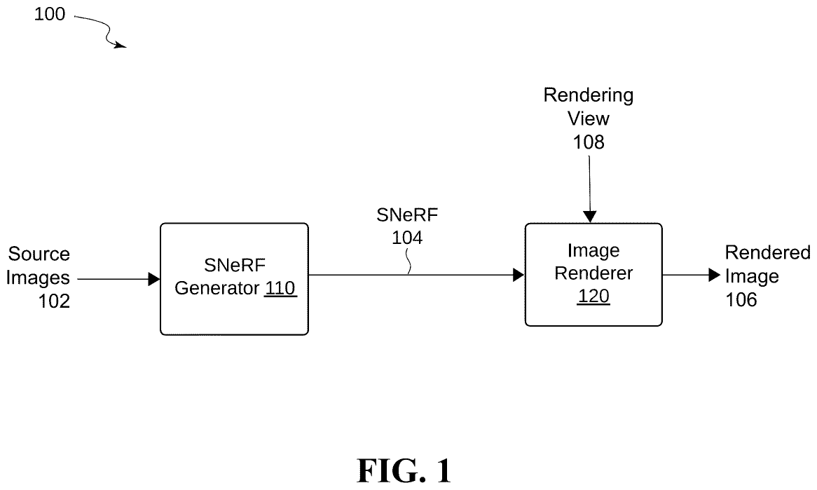

An example of a system for generating a sparse neural radiance field and for real-time image rendering via the sparse neural radiance field is illustrated at a high level in FIG. 1. As shown in FIG. 1, a system 100 includes a sparse neural radiance field (“SNeRF”) generator 110 and an image renderer 120.

The SNeRF generator 110 accesses source images 102 of a scene and generates a sparse neural radiance field 104 based on feature information extracted from the source images 102. At a high level, the sparse neural radiance field 104 is generated by decoding feature information for a set of novel views of the scene, based on the feature information extracted from the source images, and by mapping the decoded feature information to a sparse three-dimensional representation of the scene. The image encoding, decoding, and feature mapping processes can involve machine learning models which are described in greater detail further in this disclosure.

The sparse three-dimensional representation of the scene on which the sparse neural radiance field 104 is based may include a voxel grid, octree structure, or other sparse data structure to which two-dimensional neural features can be mapped. In some cases, the sparse three-dimensional data structure may be an octree structure which may be particularly well-suited to the storage of multiscale feature information. Methods for generating the underlying sparse three-dimensional representation of the scene are described in greater detail further in this disclosure.

The image renderer 120 accesses the sparse neural radiance field 104 and generates a rendered image 106 by decoding feature information stored in the sparse neural radiance field 104 with reference to a rendering view 108. At a high level, the rendered image 106 is rendered by retrieving feature information from parts of the sparse neural radiance field 104 that are captured in the defined rendering view 108, and by decoding the rendered image 106 based on the retrieved feature information. The image rendering process may involve one or more machine learning models as described in greater detail further in this disclosure.

Although described as two main functional units comprising the SNeRF generator 110 and image renderer 120, it is to be understood that this is for illustrative purposes only, and that the functionality of these units may be achieved by any number of functional units that perform the functionality described herein. Further, the components of the system 100, including the learned neural network weights, activation functions, and other architectural components of any underlying machine learning models may be embodied in non-transitory machine-readable programming instructions. These instructions may be executable by one or more processors of one or more computing devices which include memory to store programming instructions that embody the functionality described herein and one or more processor to execute the programming instructions.

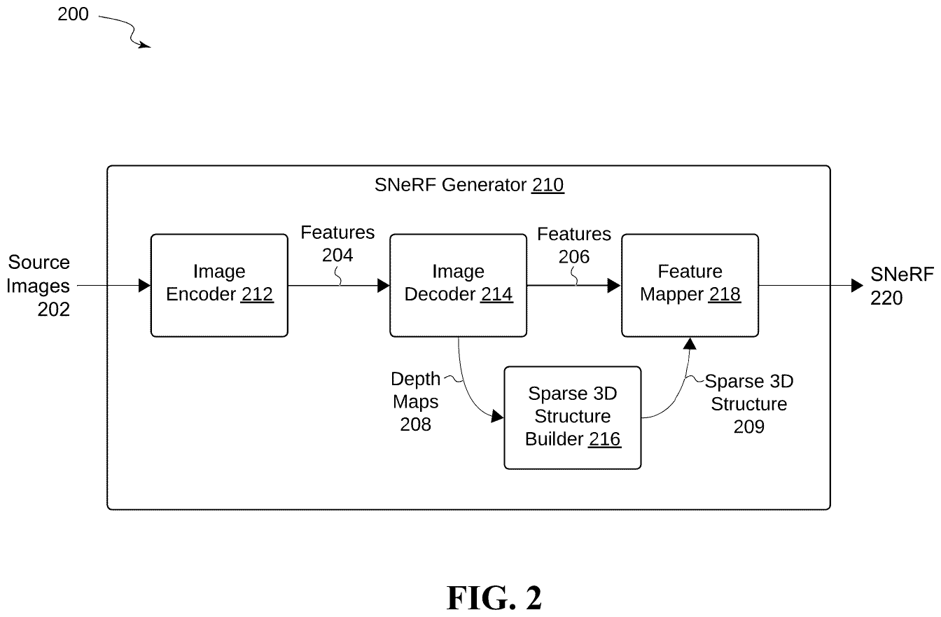

FIG. 2 is a schematic diagram of an example system 200 for generating a sparse neural radiance field. The system 200 includes a sparse neural radiance field (“SNeRF”) generator 210, which may be understood to be one example implementation of the sparse neural radiance field generator 110 of FIG. 1, shown in greater detail. The SNeRF generator 210 includes an image encoder 212, an image decoder 214, a sparse 3D structure builder 216, and a feature mapper 218.

The image encoder 212 accesses a set of source images 202 of a scene. The source images 202 comprise multiview imagery that captures the scene from multiple points of view. The image encoder 212 encodes each source image 202 into a series of multiscale feature maps, which may also be referred to as multiscale encoded feature maps, and which are denoted here as features 204. The image encoding process may involve a series of convolutional layers that progressively encode each source image 202 into the series of multiscale encoded feature maps, as described in the '041 Application.

The image decoder 214 receives a set of target views of the scene and decodes each target view into a series of multiscale feature maps, which may be referred to as multiscale decoded feature maps, and which are denoted here as features 206. The multiscale decoded feature maps are decoded based on the series of multiscale feature maps into which the source images 202 were encoded. More specifically, the image decoding process can involve progressively decoding a query, which represents the camera parameters for the target view, into the series of multiscale feature maps, by attending to the multiscale features extracted from the source images 202 of corresponding scale. The image decoding process may involve a combination of global attention, local attention, and convolutional layers, that progressively decode the query into the series of multiscale decoded feature maps, as described in the '041 Application.

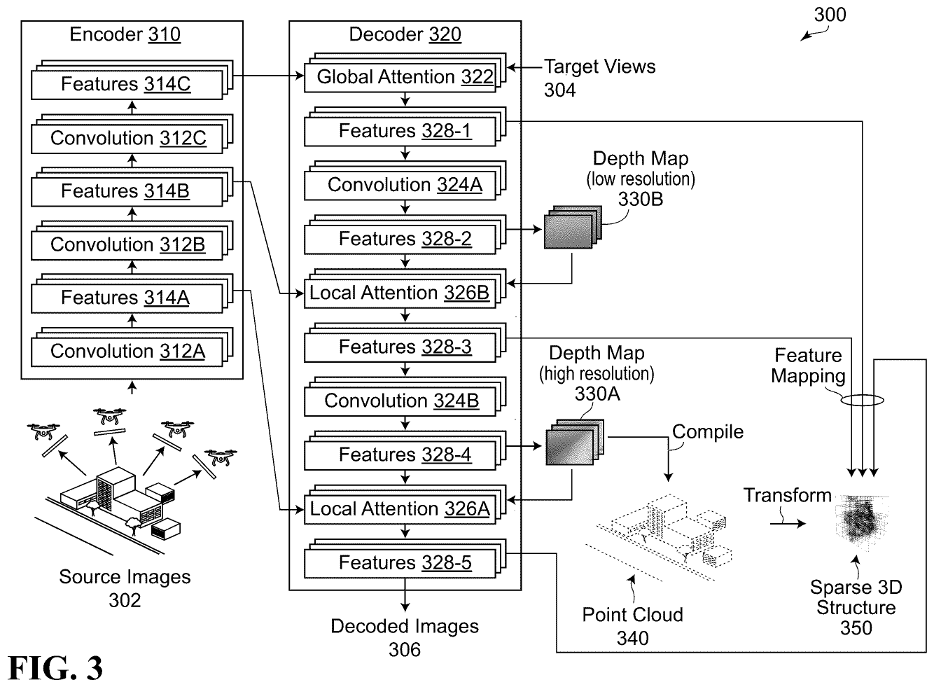

Although further details are provided below in FIG. 3, it should be noted at this stage that the image decoding process also involves generating depth maps corresponding to each of the target views, denoted here as depth maps 208. These depth maps 208 aid in the image decoding process, as described in the '041 Application. However, these depth maps 208 can be further leveraged to build a sparse three-dimensional representation of the scene, indicated here as sparse 3D structure 209, to which the 2D neural features of the decoded images (i.e., features 206) can be mapped. In other words, the sparse 3D structure builder 216 accesses the depth maps 208 and generates the sparse 3D structure 209 based on the depth maps 208.

One way in which the sparse 3D structure builder 216 can generate the sparse 3D structure 209 based on the depth maps 208 involves first compiling the depth maps 208 into a point cloud. Optionally, the point cloud can be compiled using any suitable techniques for filtering, averaging, or blending, that would be suitable for generating a point cloud from a set of depth maps. The resulting point cloud is a dense representation of the surface structure of the scene which serves as the basis for the sparse 3D structure 209.

The sparse 3D structure builder 216 may then transform the point cloud into a three-dimensional data structure that partitions the three-dimensional space occupied by the scene into distinct volumes, such as a voxel grid. The three-dimensional data structure could also be an octree structure, which recursively divides the scene into a hierarchy of cells (i.e., cubic unit volumes) at different scales. The point cloud can be transformed into the sparse three-dimensional structure by any suitable technique (e.g., in the case of an octree structure, iteratively dividing the cells of the octree that contain a point from the point cloud until a desired level of resolution is reached). An octree representation of the scene may be advantageous as the structure of the octree would be relatively more dense around the surfaces of the objects in the scene (where more feature detail is desired) and relatively less dense in the open spaces of the scene (where less feature detail is desired). In any case, the sparse 3D structure 209 provides a basis structure to which the features 206 can be mapped for future rendering purposes.

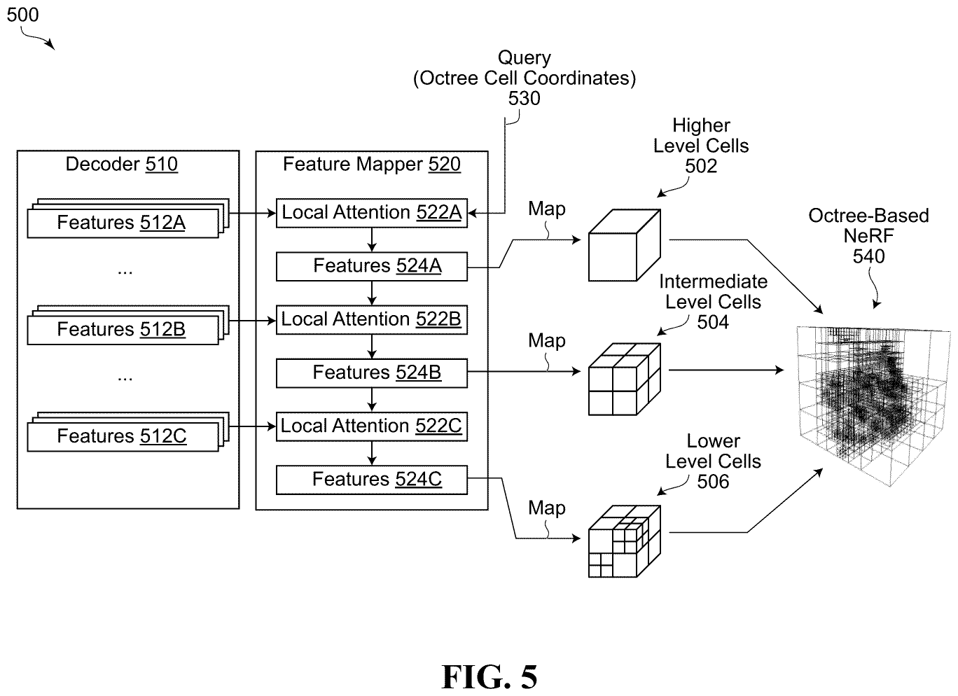

The feature mapper 218 maps the features of the series of multiscale feature maps decoded from the target views (i.e., features 206) to the sparse 3D structure 209. In some implementations, the features 206 may be mapped to the various parts of the sparse 3D structure 209 (e.g., cells of an octree) in accordance with any suitable heuristics. For example, for each part of the sparse 3D structure 209 (e.g., for each cell of the octree), the relevant features from each decoded image can be mapped to the part in an equally-weighted manner. As another example, the relevant features from each decoded image can be mapped to the part with a weighting that is determined by some form of heuristic, such as a relevance score, or another heuristic. However, it may be advantageous to map the features 206 to the parts of the sparse 3D structure 209 in accordance with a learned process, in which the relative weight of each feature is determined through a trained process, as described in greater detail further in this disclosure, in FIG. 5. In any case, the result is the sparse neural radiance field 220 which can be used for direct image rendering.

Although the SNeRF generator 210 is described as comprising the four main functional units shown, it is to be understood that this is for illustrative purposes only, and that the functionality of these units may be achieved by any number of functional units that perform the functionality described herein. Further, the components of the system 200, including the learned neural network weights, activation functions, and other architectural components of any underlying machine learning models, may be embodied in non-transitory machine-readable programming instructions. These instructions may be executable by one or more processors of one or more computing devices which include memory to store programming instructions that embody the functionality described herein and one or more processor to execute the programming instructions.

FIG. 3 illustrates another example system 300 for generating a sparse neural radiance field. The system 300 can be understood to be similar to the system 200 of FIG. 2 with certain components described in greater detail. Thus, the system 300 includes an encoder 310 and a decoder 320, which can be considered example implementations of the image encoder 212 and image decoder 214 of FIG. 2, respectively. The system 300 provides a more detailed description of the multiscale nature of the feature extraction process employed by the encoder 310 and the feature decoding process employed by the decoder 320, and further illustrates how this multiscale feature information is used to generate a sparse 3D structure 350, which can be understood to be similar to the sparse 3D structure 209 of FIG. 2.

The encoder 310 comprises a series of convolutional layers, indicated here as convolutions 312, which encode each source image 302 of a set of source images 302 into a series of multiscale encoded feature maps, indicated here as features 314. As shown in FIG. 3, the source images 302 are depicted as representing a set of aerial images captured by one or more drones flying overhead an exterior scene comprising a group of buildings, roads, and trees in an urban environment. However, it is to be understood that the source images 302 may include imagery captured by any sort of imagery capture device depicting any sort of scene, including interior and exterior scenes.

In the present example, the encoder 310 is depicted as comprising three sets of convolutional layers 312 which produce three feature maps 314 at different scales. Thus, the convolutional layer 312A processes the source images 302 (i.e., the RGB layer) to produce feature maps 314A, whereas the convolutional layer 312B processes the feature maps 314A to produce feature maps 314B, and whereas the convolutional layer 312C processes the feature maps 314B to produce feature maps 314C. The feature maps 314 may tend to increase in numbers of channels and decrease in resolution throughout the encoding process. Thus, the feature maps 314A represent the lowest-level (i.e., highest resolution) features extracted from the source images 302, whereas the feature maps 314C represent the highest-level (i.e., lowest resolution) features, and the feature maps 314B represent the intermediate level features. Each of these three scales of feature maps 314 are encoded for each individual source image 302.

The scale of these feature maps 314 may correspond, at least in part, to the scale of the source images 302. For example, if the source images 302 were captured at native ground resolution of about 0.25 m, then the feature maps 314A, may encode feature information at about 0.25 m resolution, whereas the feature maps 314B may encode scaled-up feature information at about 0.5 m resolution, and whereas the feature maps 314C may encode further scaled-up feature information at about 1.0 m resolution.

Although three convolutional layers are depicted, it should be understood that more or fewer convolutional layers may be applied depending on the scales of the feature resolutions desired. Further, it should be understood that each convolutional layer may be applied in accordance with any known techniques, including the use of several convolutions of varying kernel size, and that each downsampling layer may be applied in accordance with any known techniques. Further details about the image encoding process may be found in the '041 Application.

The decoder 320 comprises a global attention layer 322 and a series of convolutional layers 324 and local attention layers 326, which decode representations of target views 304 to produce a series of multiscale decoded feature maps, indicated here as features 328, which ultimately are used to produce decoded images 306. The representations of target views 304 may comprise embedded representations of camera parameters corresponding to the target views 304, as described in the '041 Application. Attention may be computed in any suitable manner, such as performing scaled dot product between cross-attention values (see, e.g., Vaswani, Ashish, et al. “Attention is all you need.” Advances in neural information processing systems 30 (2017)).

The attention layers 322, 326 determine the most relevant feature information to be extracted from the source images 302 for a particular target view 304. The global attention layer 322 attends to the higher-level feature information extracted at the encoder 310, whereas the local attention layers 326 attend to the intermediate and lower-level feature information. Thus, the global attention layer 322 attends to the highest-level feature map 314C, the local attention layer 326B attends to the intermediate-level feature map 314B, and the local attention layer 326A attends to the lowest-level feature map 314A.

The convolutional layers 324 fuse together the feature information extracted by the previous attention layer and upsample the feature information to the next level of scale. Thus, the convolutional layer 324A processes feature map 328-1, which would have been extracted by the global attention layer 322 at the highest-level (lowest-resolution) scale (e.g., 1.0 m), to produce feature map 328-2 at the intermediate-level scale (e.g., 0.5 m). The convolutional layer 324B then processes feature map 328-3, which would have been extracted by the local attention layer 326B at the intermediate-level scale (e.g., 0.5 m), to produce feature map 328-4 at the lowest-level (highest-resolution) scale (e.g., 0.25 m). This lowest-level feature map 328-4 is further processed by local attention layer 326A at the same scale to produce the final decoded feature map 328-5, from which a decoded image 306 can be readily obtained (e.g., RGB layer), through, for example, an activation layer and/or further neural processing. It should be understood that more or fewer layers of convolutional layers 324 and/or attention layers 322, 326 may be employed as appropriate given the desired scales of feature resolution. Further details about the image decoding process may be found in the '041 Application.

As an intermediate process, each local attention layer 326 produces a depth map 330 for the scene, based on the previous feature map 328. For example, the local attention layer 326B generates a depth map 330B based on the feature map 328-2, and the local attention layer 326A generates a depth map 330A based on the feature map 328-4. The depth maps 330 may be generated by any suitable technique such as a combination of convolutional and/or other neural layers, and the resulting depth maps 330 may correspond in scale to the scale of the feature maps 328 used (e.g., the depth map 330A may be at 0.25 m resolution and the depth map 330B may be at 0.5 m resolution).

Although these depth maps 330 are used to aid in the image decoding process, as described in the '041 Application, these depth maps 330 also provide a detailed description of the surface structure of the scene. Further, by processing several target views 304 of a scene, a detailed description of the surface structure of the scene as captured from multiple points of view can be compiled. Thus, following the last stage of the decoder 320, at which the highest-resolution depth map 330A is generated, the highest-resolution depth maps 330A for all of the target views 304 can be combined to form a point cloud 340. This point cloud 340 can then be transformed into a sparse 3D structure 350, as described above, such as voxel grid or octree structure. This sparse 3D structure 350 provides a sparse three-dimensional data structure that captures the surface structure of the scene to which the feature information generated by decoding the decoded images 306 (i.e., features 328) can be mapped.

It should be noted here that it may be advantageous to map the decoded feature information 328 generated at the decoder 320, as opposed to the encoded feature information 314 generated at the encoder 310, to the sparse 3D structure 350, for several reasons. First, the decoded feature information 328 is decoded based on the encoded feature information 314 from multiple source images 302, and is therefore enriched with multiview information, that is not present in the encoded feature information 314 itself. Second, the decoded feature information 328 is not only generated based on the encoded feature information 314 directly, but also fuses together, via the convolutional layers 324, this multiview feature information, to gain a deeper understanding of the scene. Third, the decoded feature information 328 is also decoded with reference to the depth maps 330, and is therefore enriched with structural information on the scene, that is also not present in the encoded feature information 314 itself.

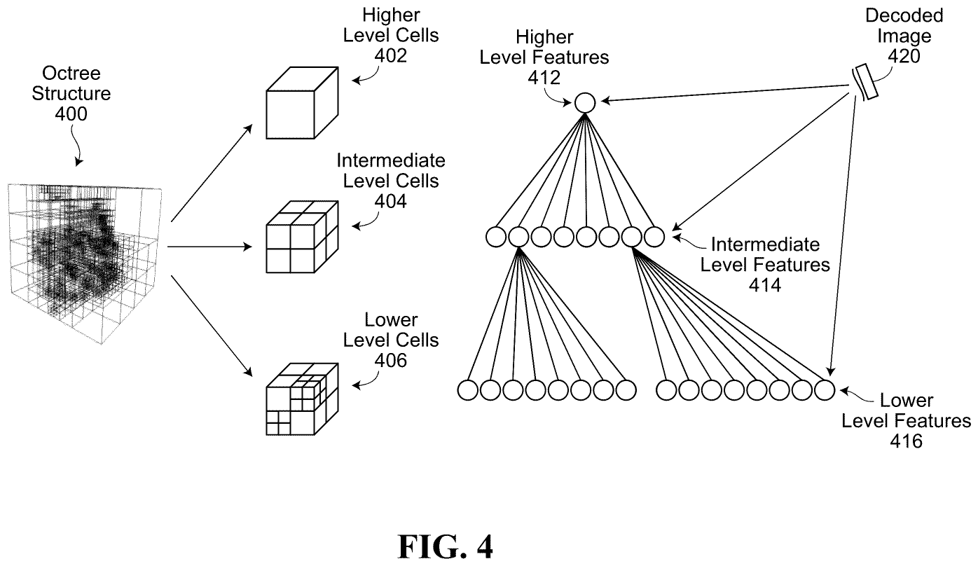

As mentioned above, an octree structure lends itself well to the storage of multiscale feature information. Thus, where the sparse 3D structure 350 comprises an octree structure, and multiscale feature information is desired, then the features 328 can be mapped to the sparse 3D structure 350 in a multiscale fashion. However, in other cases where multiscale feature information is not desired, the sparse 3D structure 350 can comprise a voxel grid or similar structure composed of distinct volumes of uniform size (which still can be sparsely distributed), and a single scale of feature information can be mapped to the voxel grid. The case where the sparse 3D structure 350 comprises an octree structure to which the features 328 are mapped in a multiscale fashion is illustrated in FIG. 4, below.

As shown in FIG. 4, the feature information for a decoded image 420 is mapped to an octree structure 400 in a multiscale fashion to form an octree-based neural radiance field. In other words, the higher-level (i.e., lower resolution) features 412 for a decoded image 420 are mapped to the higher-level cells 402 of the octree structure 400, the lower-level (i.e., higher resolution) features 416 are mapped to the lower-level cells 406, and the intermediate-level features 414 are mapped to the intermediate-level cells 404.

To give a numerical example, if the decoded image 420 was decoded at ground resolution of about 0.25 m (and this was the highest-resolution scale), then the lower-level features 416 would correspond to about 0.25 m resolution, and these features would be mapped to the lower-level cells 406, which would have corresponding dimensionality of about 0.25 m. Similarly, the intermediate-level features 414 may correspond to about 0.5 m resolution, and these features would be mapped to the intermediate-level cells 404, which would have corresponding dimensionality of about 0.5 m. Finally, the higher-level features 412 may correspond to about 1.0 m resolution, and these features would be mapped to the higher-level cells 402, which would have corresponding dimensionality of about 1.0 m. In general, the scale of the features mapped to the cells of the octree should substantially match the scale of the octree cells.

As a result of the sparse structure of the octree structure 400, the higher-level cells 402, which span larger volumes of the scene, will be more sparsely-attributed with the higher-level features 412 of the scene, whereas the lower-level cells 406, which capture the more detailed surface structure of the scene, will be more densely-attributed with the lower-level features 416 of the scene. Advantageously, the result is a three-dimensional representation of the scene that is sparse on feature detail in the empty spaces of the scene but is rich in feature detail near the surface structure of the scene, which provides for an efficient image rendering process, as described later in this disclosure.

As mentioned above, the feature information of the decoded image 420 (and other decoded images) may be mapped to the octree structure 400 in accordance with any suitable heuristics, such as equal weighing, or weighing based on a relevance score. However, it may be advantageous to map the decoded features to the octree structure 400 in accordance with a learned process, in which the relative weight of each set of features of each decoded image is determined through a trained process, as described below in FIG. 5.

FIG. 5 illustrates an example system 500 for mapping feature information to an octree structure in a multiscale fashion in accordance with a learned process. The system 500 includes a decoder 510 and a feature mapper 520. The decoder 510 may be understood to be analogous to the decoder 320 of FIG. 3, with its various components omitted for brevity, showing only the resulting features 512 decoded at multiple scales for each decoded image. The feature mapper 520 may be understood to be one example implementation of the feature mapper 218 of FIG. 2, shown in greater detail.

The feature mapper 520 includes a series of local attention layers 522 which progressively decode a query 530 into a series of multiscale feature maps, indicated here as features 524, which are to be mapped to the cells of an octree structure at the corresponding scales, to form an octree-based neural radiance field 540.

The feature mapping process begins with the query 530 being processed by the highest-level local attention layer 522A. The initial query 530 represents the coordinates of a cell of the octree structure at the highest level of the octree (e.g., an embedded representation of such coordinates). For example, if a scene is divided into an octree comprising 16 cells at the highest level, then the query 530 represents the coordinates of one of these cells. The feature mapping process should ultimately be repeated for each cell at the highest level of the octree.

This local attention layer 522A attends to the features 512A for each of the decoded images at the highest level of the decoder 510. The keys used in the attention calculation can be representations of these features 512A concatenated with representations of the camera parameters that represent the view from which the decoded images were decoded. The local attention layer 522A determines the most relevant features 512A to be incorporated into the resulting feature map 524A. Attention may be computed in any suitable manner, such as performing scaled dot product between cross-attention values (see, e.g., “Attention is all you need”, above).

This process continues through each of the local attention layers 522, with the query at each local attention layer 522 comprising the previously obtained set of features, upsampled and concatenated with a representation of octree cell coordinates, and with the set of keys comprising representations of the multiscale features at the corresponding scale. Thus, the local attention layer 522B processes the features 524A and features 512B to produce features 524B, and the local attention layer 522C processes the features 524B and features 512C to produce features 524C.

Each set of features 524 is mapped to the octree structure at the appropriate scale. Thus, the features 524A are mapped to the higher-level cells 502 of the octree structure, the features 524B are mapped to the intermediate-level cells 504, and the features 524C are mapped to the lower-level cells 506. The result is essentially a learned weighted contribution of the features of the decoded images mapped to the cells of the octree structure in a manner that produces the most accurate rendered images. This feature mapping process can be trained end to end on image loss based on images rendered by the image rendering process described further in this disclosure.

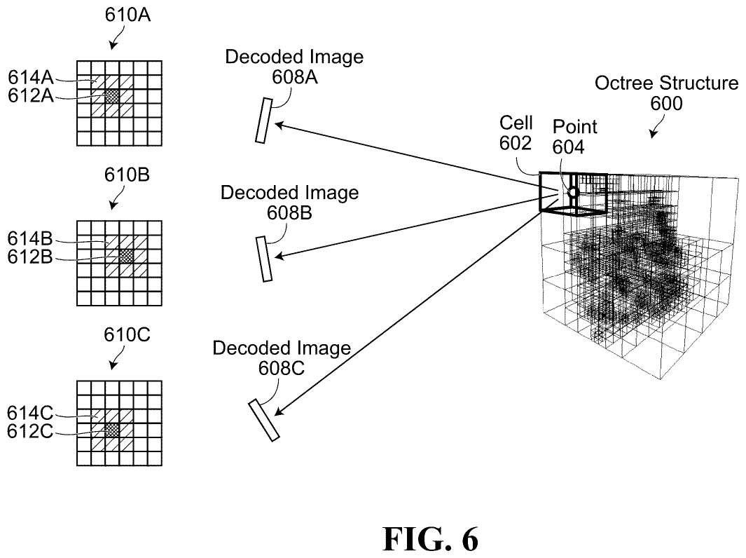

Each local attention layer 522 determines the most relevant features 512 to be included in the attention calculation by applying a feature projection process that is similar to the depth map feature projection process described in the '041 Application. This process limits the number of features required for the attention calculation and incorporates a spatial understanding into the feature mapping process. This process, which may be referred to as an octree cell feature projection process, is illustrated in FIG. 6, below.

As shown in FIG. 6, a point 604 (e.g., a center point) within an octree cell 602 of an octree structure 600 is projected to the corresponding point on the image plane of each decoded image 608A, 608B, 608C. Each decoded image 608A, 608B, 608C is associated with a feature map 610A, 610B, 610C respectively, of a scale that corresponds with the scale of the octree cell 602. For example, the decoded feature maps 610A, 610B, 610C may be understood to be examples of the highest-level feature map 524A of FIG. 5, and the octree cell 602 may understood to be an example of one of the higher-level cells 502 of FIG. 5.

The point 604 is projected to a location corresponding to a feature on each feature map 610A, 610B, 610C, indicated here as the intersected features 612A, 612B, 612C. Each of the intersected features 612A, 612B, 612C are used in the local attention calculation. Further, a set of “local” or “surrounding” features 614A, 614B, 614C may also be included in the local attention calculation. The size and shape of the area around the intersected features 612A, 612B, 612C that captures these surrounding features 614A, 614B, 614C may be determined by any suitable heuristic. For example, as shown, the surrounding features 614A, 614B, 614C may comprise 3×3 grid surrounding the intersected features 612A, 612B, 612C. However, other rules may be used to determine a set of features that are in sufficiently close proximity to the intersected features 612A, 612B, 612C to be included in the local attention calculation.

The octree cell feature projection process described above should be repeated for each cell at each scale of the octree structure 600 until each cell is attributed with a weighted combination of features derived from one or more of the decoded images, which can be queried for directly rendering new images, as described below.

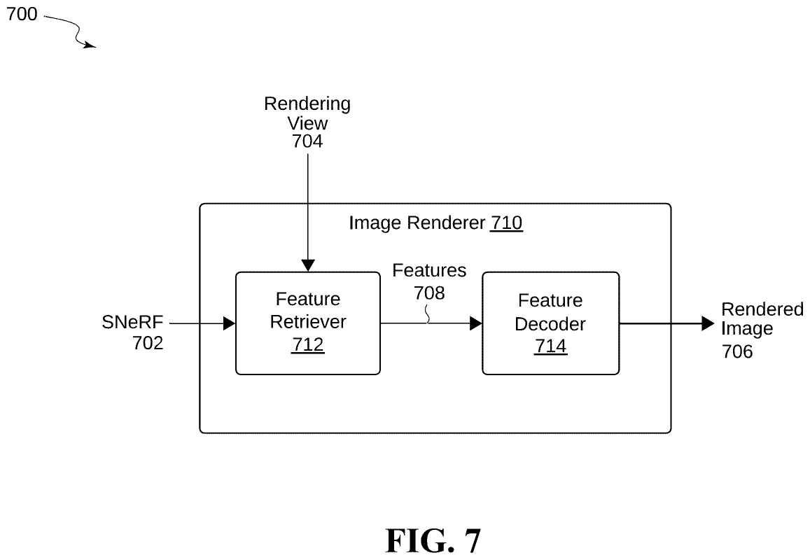

FIG. 7 is a schematic diagram of an example system 700 for real-time image rendering via a sparse neural radiance field. As shown in FIG. 7, the system 700 includes an image renderer 710. The image renderer 710 may be understood to be one example implementation of the image renderer 120 of FIG. 1, shown in greater detail. The image renderer 710 includes a feature retriever 712 and a feature decoder 714.

The feature retriever 712 accesses a sparse neural radiance field 702, to which a set of multiscale feature information from a set of decoded images has been mapped, as described above, such as in the case of an octree-based neural radiance field. The feature retriever 712 receives a rendering view 704, which may refer to a representation of the corresponding camera parameters (e.g., an embedded representation thereof), as described above. The feature retriever 712 then determines which parts of the sparse neural radiance field 702 (e.g., the cells of the octree) should be used to render the rendered image 706. The retrieved features are indicated here as features 708.

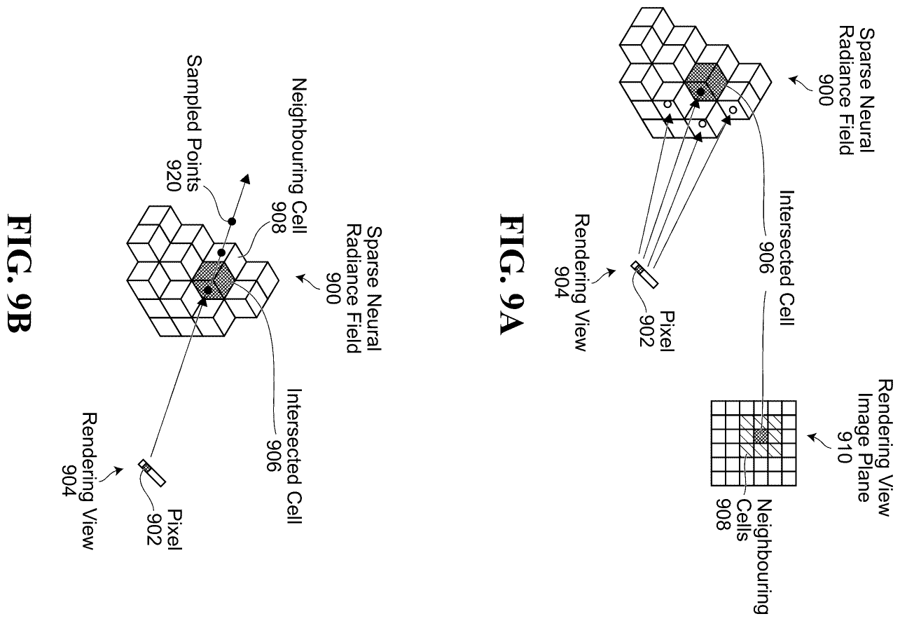

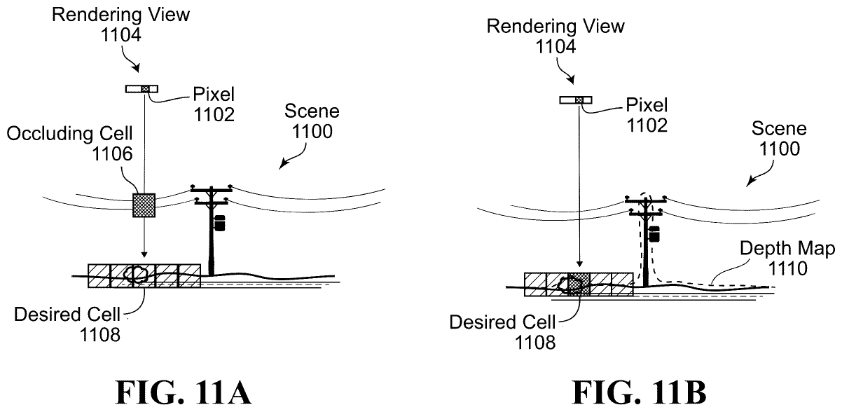

In the most straightforward implementation, the feature retriever 712 may determine which parts of the sparse neural radiance field 702 to use to render the rendered image 706 by simply determining which parts are captured (i.e., within view) of the rendering view 704. In other words, the feature retriever 712 may simply project each pixel of the image-to-be-rendered to the sparse neural radiance field 702 and return the first part (e.g., cell) of the sparse neural radiance field 702 that is intersected. However, in some implementations, additional parts of the sparse neural radiance field 702 can also be considered, as described below in FIGS. 9A and 9B. In general, the feature retriever 712 may also capture feature information stored in nearby neighbouring cells which are in close proximity to the cells that are directly intersected by projecting pixel locations through the rendering view 704, as described below, in FIG. 9A and FIG. 9B. Further, in some implementations, the rendering process may involve a learned process that involves applying attention mechanisms and generating depth maps to aid in the image rendering process, as described below, in FIG. 11.

Regardless of how the feature retriever 712 operates, after the features 708 are obtained, the feature decoder 714 decodes these features to render the rendered image 706. The feature decoder 714 may decode these features 708 into the final image (i.e., RGB layer) by simply applying an activation function (e.g., softmax) and/or by applying other additional neural processing.

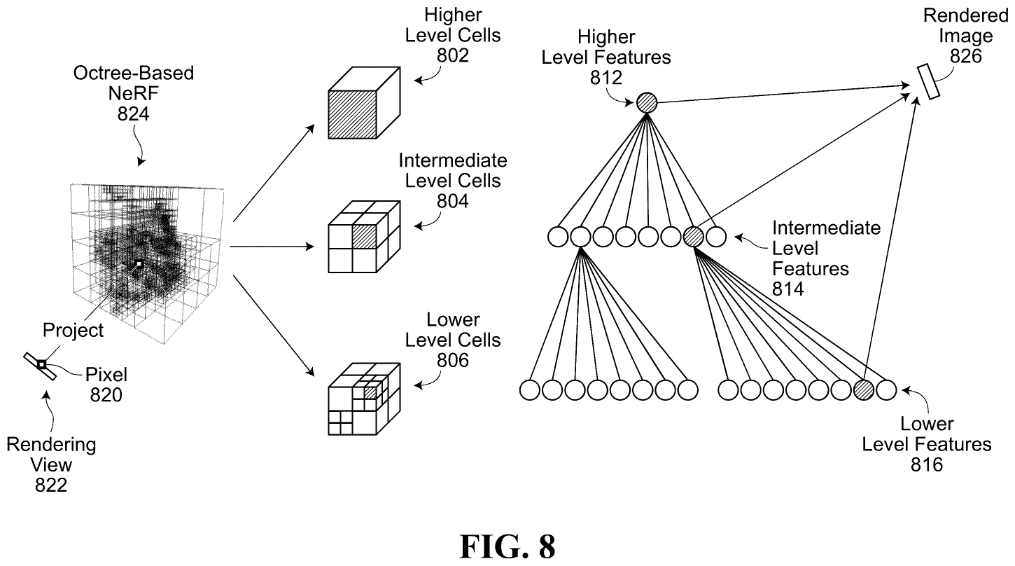

It should be noted here that since the sparse neural radiance field 702 stores multiscale feature information, the rendered image 706 can be rendered at any scale for which there are features stored in the sparse neural radiance field 702. The rendered image 706 can also be rendered at scales between those which are stored in the sparse neural radiance field 702 by applying any suitable heuristic, such as, for example, a technique for blending the features stored at the neighbouring scales. Regarding the ability to query features stored in the sparse neural radiance field 702 at different scales, this aspect is illustrated in FIG. 8, in the case where the sparse neural radiance field 702 is in the form of an octree-based neural radiance field.

As shown in FIG. 8, a pixel 820, which represents one of a set of pixels corresponding to a rendering view 822, is projected toward an octree-based NeRF 824. The first cell of the octree-based NeRF 824 of the desired resolution that is intersected by the projected ray is selected as the cell that contains the feature information that will be used to render the pixel 820. Repeating this process for each pixel of the rendering view 822 yields the set of feature information required to render the full rendered image 826, which can be readily determined by further processing including further neural processing and/or a final activation function.

To give a numerical example, if the desired scale as defined in the camera parameters for the rendering view 822 corresponds to the scale of the higher-level cells 802 (e.g., 1.0 m), then the higher-level features 812 stored at the higher-level cell 802 that is intersected are used to render the pixel 820. Similarly, if the desired scale corresponds to the scale of the intermediate-level cells 804 (e.g., 0.5 m), then the intermediate-level features 814 stored at the intermediate-level cell 804 that is intersected are used to render the pixel 820. Finally, if the desired scale corresponds to the scale of the lower-level cells 806 (e.g., 0.25 m), then the lower-level features 816 stored at the lower-level cell 806 that is intersected are used to render the rendered image 826. The features stored in the cells of the octree-based NeRF 824 of other scales need not be included in the rendering process.

Thus, the octree-based NeRF 824 can store feature information both at very high resolutions and at very lower resolutions, and advantageously, one scale of feature information stored in the octree-based NeRF 824 can be queried without the need to process feature information stored at another scale. For example, even in the case where a large octree-based NeRF 820 stores detailed feature information across a large area of a city (e.g., for rendering detailed images of small scenes within the larger city), this detailed feature information need not be processed when rendering a large low-resolution overview image of the area.

As mentioned above in FIG. 7, in some implementations, the feature retriever 712 may also capture feature information stored in nearby neighbouring cells which are in close proximity to the cells that are directly intersected by projecting pixel through the rendering view 704. At least two ways in which the feature information stored in additional nearby cells can be captured are described in FIG. 9A, and FIG. 9B, below.

FIG. 9A illustrates one example of how the cells of a sparse neural radiance field that are in close proximity to an intersected cell can be captured in an image rendering process. In FIG. 9A, a pixel 902 of a rendering view 904 is projected toward a sparse neural radiance field 900 and intersects the sparse neural radiance field 900 at an intersected cell 906. The intersected cell 906 is surrounded by several neighbouring cells 908 which are directly adjacent to the intersected cell 906 when projected onto a rendering view image plane 910. These neighbouring cells 908 can be included in a local attention calculation as described above in FIG. 7. In some cases, larger groups of neighbouring cells 906 can also be included (e.g., 3×3 grid, 9×9 grid, or another shape) according to any suitable heuristic.

FIG. 9B illustrates another example of how the cells of a sparse neural radiance field that are in close proximity to an intersected cell can be captured for an image rendering process. In FIG. 9B, again, a pixel 902 of a rendering view 904 is projected toward a sparse neural radiance field 900 and intersects the sparse neural radiance field 900 at an intersected cell 906. However, in this case, a group of points 920 are sampled along the path of the projection ray to capture any neighbouring cells 908 along the path. As above, these neighbouring cells 908 can be included in a local attention calculation as described above in FIG. 7. In some cases, the sampled points 920 can be spaced apart at fixed distances following the intersected cell 906, or can be sampled before and after the intersected cell 906, or according to any suitable heuristic.

In still further implementations, combinations of the approaches described above for capturing neighbouring cells may be applied. For example, when combining the approach illustrated in FIG. 9A with the approach illustrated in FIG. 9B, the features captured by sampling points along a projection ray as in FIG. 9B can be combined into a composite feature (e.g., by application of another attention mechanism), and each of these composite features can be treated the same way as the neighbouring features in FIG. 9A when projected onto the imagine plane, and all of the neighbouring composite features can included together in the local attention calculation.

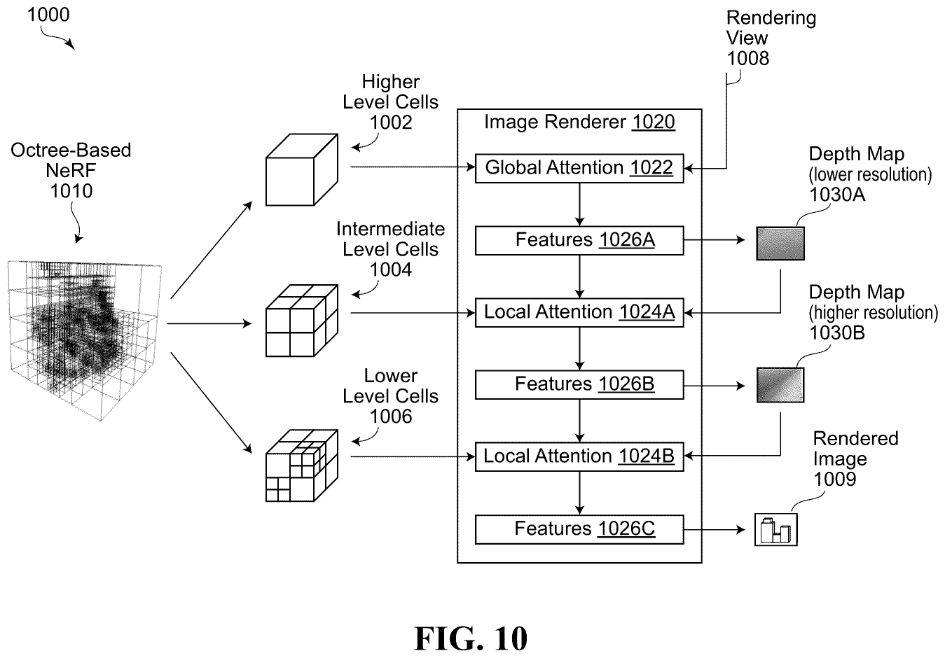

Moreover, as mentioned above in FIG. 7, the image rendering process can be further improved by applying a learned process that involves applying attention mechanisms to determine the relevant feature information for image rendering and generating depth maps to aid in the image rendering process, as described in FIG. 10, below.

FIG. 10 illustrates another example system 1000 for real-time image rendering via an octree-based neural radiance field. The system 1000 includes an octree-based neural radiance field (NeRF) 1010 and an image renderer 1020. The octree-based NeRF 1010 may be understood to be an example of the sparse neural radiance field 702 of FIG. 7, and the image renderer 1020 may be understood to be an example of the image renderer 710 of FIG. 7, shown in greater detail.

The octree-based NeRF 1010 is an octree representation of a scene comprising a hierarchical structure of cells that are divided into various scales ranging from higher-level octree cells 1002 to intermediate-level octree cells 1004 to lower-level octree cells 1006. As described above, multiscale feature information generated by decoding a set of target views into a set of decoded images is mapped to the cells of the octree-based NeRF 1010,

Similar to the decoder 320 of FIG. 3, the image renderer 1020 comprises a global attention layer 1022 and a series of local attention layers 1024 which decode a representation of a rendering view 1008 to produce a series of multiscale feature maps, indicated here as features 1026, which ultimately are used to produce a rendered image 1009. However, in contrast, the attention layers 1024 of the image renderer 1020 attend to the features stored in the octree-based NeRF 1010, rather than to the features of the initially decoded images that were used to generate the octree-based NeRF 1010. Further, the image renderer 1020 does not contain any convolutional layers to fuse together multiscale features, as the fusion of multiscale features was already previously performed before the features were mapped to the octree-based NeRF 1010. This lack of convolutional layers greatly improves the speed and efficiency of the image rendering process compared to the initial image decoding process.

The global attention layer 1022 attends to the higher-level cells 1002 stored at the octree-based NeRF 1010 to generate a first set of features 1026A. The query for this global attention calculation may comprise a representation of the camera parameters corresponding to the rendering view 1008 (e.g., an embedded representation thereof). Attention may be computed in any suitable manner, such as performing scaled dot product between cross-attention values (see, e.g., “Attention is all you need”, above).

In some implementations, where the size of the Octree-Based NeRF 1010 is not prohibitively large, the global attention layer 1022 may attend to all of the higher-level cells 1002 in the Octree-Based NeRF, regardless of which cells are captured in the rendering view 1008. In this case, the keys for the global attention calculation may comprise representations of the features stored at each of the higher-level cells 1002 of the octree-based NeRF 1010.

In other implementations, in which the size of the Octree-based NeRF 1010 would be prohibitively large for an attention calculation across all of the higher-level cells, the global attention layer 1022 may attend to only the higher-level cells 1002 of the Octree-Based NeRF which are captured within the rendering view 1008. In other words, the global attention layer 1022 first identifies the un-occluded higher-level cells 1002 that are within the rendering view 1008, and then selects these cells to be included in an attention calculation. In either case, the result is a two-dimensional feature map, indicated here as features 1026A, which represents the higher-level features of the rendered image 1009.

These features 1026A are then used in the first local attention layer 1024A. These features 1026A are also used to generate a lower-resolution depth map 1030A to aid in the image rendering process, as described later in this disclosure in FIGS. 11A and 11B.

The first local attention layer 1024A determines the most relevant feature information stored in the intermediate-level cells 1004 to be included in a local attention calculation, for example, as described in FIG. 9A and/or FIG. 9B, above. This feature information is included in a local attention calculation to generate a second set of features 1026B. The query for this local attention calculation may comprises the previous features 1026A, concatenated with the representation of the camera parameters corresponding to the rendering view 1008 upscaled to the appropriate scale. The keys for the local attention calculation may comprise representations of the features stored at the intermediate-level cells 1004 of the octree-based NeRF 1010 that have been grouped together for the local attention calculation.

These features 1026B are then used in the second local attention layer 1024B. These features are also used to generate a higher-resolution depth map 1030B to aid in the image rendering process, as described later in this disclosure in FIGS. 11A and 11B.

Similarly, the second local attention layer 1024B determines the most relevant feature information stored in the lower-level cells 1006 to be included in a local attention calculation, for example, as described in FIG. 9A and/or FIG. 9B, above. This feature information is included in a local attention calculation to generate a final set of features 1026C. The query for this local attention calculation may comprise the previous features 1026B concatenated with the representation of the camera parameters corresponding to the rendering view 1008 upscaled to the appropriate scale. The keys for this local attention calculation may comprise representations of the features stored at the lower-level cells 1006 of the octree-based NeRF 1010. The resulting features 1026C can be ultimately used to render the rendered image 1009 (e.g., by an activation function and/or further neural processing).

This image rendering process can be trained end to end on image loss based on images rendered, in parallel with training of the feature mapping process, as described earlier in this disclosure.

As described above, the features 1026 are used to generate depth maps 1030 corresponding to the rendering view 1008. These depths maps 1030 can inform the local attention layers 1024 as to the locations of points to be sample and the locations of neighbouring cells to be considered. In some cases, it can be advantageous to reference these depth maps 1030 to avoid occlusions that would otherwise case undesirable rendering artefacts. For comparison, an illustration of an image rendering process without the aid of depth maps is provided in FIG. 11A, in contrast to an image rendering process that is performed with the aid of a depth map provided in FIG. 11B.

FIG. 11A depicts a scene 1100 comprising an electrical utility pole suspending electrical wires over a ground surface covered by various landcover elements depicted as including a shrub and a road. Although not shown in its entirety, it is to be understood that the scene 1100 has been modeled by a sparse neural radiance field as described in this disclosure.

A rendering view 1104 is defined with a particular field of view and at a particular scale with the intention of capturing an image of the ground-level detail of the scene 1100. However, due to the presence of the suspended electrical wires, a pixel 1102 that is projected toward the scene 1100 may inadvertently intersect an occluding cell 1106 of the sparse neural radiance field (e.g., occupied by an overhanging wire), and may miss a desired cell 1108 (e.g., at ground level). Thus, at least some of the feature information stored in the undesired occluding cell 1106 (e.g., the overhanging wire) may go toward rendering the image instead of the feature information stored in the desired cell 1108 (e.g., at ground level). This unwanted feature information may interfere with a more accurate rendering of the ground-level detail. However, this interference may be advantageously avoided by leveraging a depth map, as shown in FIG. 11B.

FIG. 11B depicts the same scene 1100 which is modeled by the same sparse neural radiance field. However, in contrast to FIG. 11A, a depth map 1110 has also been rendered for the scene. The depth map 1110 may have been generated by leveraging the previously generated set of features, as described in FIG. 10, above. As shown, the depth map 1110 follows the contours of the ground level elements and does not include any points along any of the wires of the electrical utility pole. When using a depth map 1110, the system can force the image to be rendered using only the feature information stored in cells that overlap with the depth map 1110. In other words, the system can directly determine that the pixel 1102 projects to the depth map 1110 at a particular point, and that this particular point is located within the desired cell 1108, and that therefore the pixel 1102 should be rendered using the feature information stored in the desired cell 1108. Given that the desired cell 1108 is on the desired surface to be rendered (i.e., the ground), a more accurate rendering of the desired image (e.g., at ground level) can be rendered.

The reason the depth map 1110 follows the contours of the ground level elements while avoiding the overhanging wires can be a result of training. Since the depth map generation process can be trained as part of the end-to-end training process, along with the feature mapping process and the image rendering process, the depth map generation process can learn to generate depth maps in a way that produces the most accurate image rendering. The depth map generation process can therefore learn to avoid unwanted occlusions such as overhanging wires and other occlusions.

It should therefore be seen that the systems and methods for generating sparse neural radiance fields and rendering images via these sparse neural radiance fields can produce highly accurate image renderings of scenes. These techniques are generalizable across scenes, can inherently account for occlusions, shadows, and lighting differences, and can inherently model the three-dimensional structure of a scene based solely on image data. Furthermore, directly rendering images from a sparse neural radiance field can be efficiently performed at speeds that enable real-time image rendering.

In terms of applications, the techniques described above may be applied in any use case for real-time image rendering of novel views, including real-time image rendering of objects, interior scenes, exterior scenes, even including large outdoor scenes comprising large structures such as buildings, roads, and landscapes, for three-dimensional scene reconstruction, virtual reality, augmentation, digital twin, and other applications.

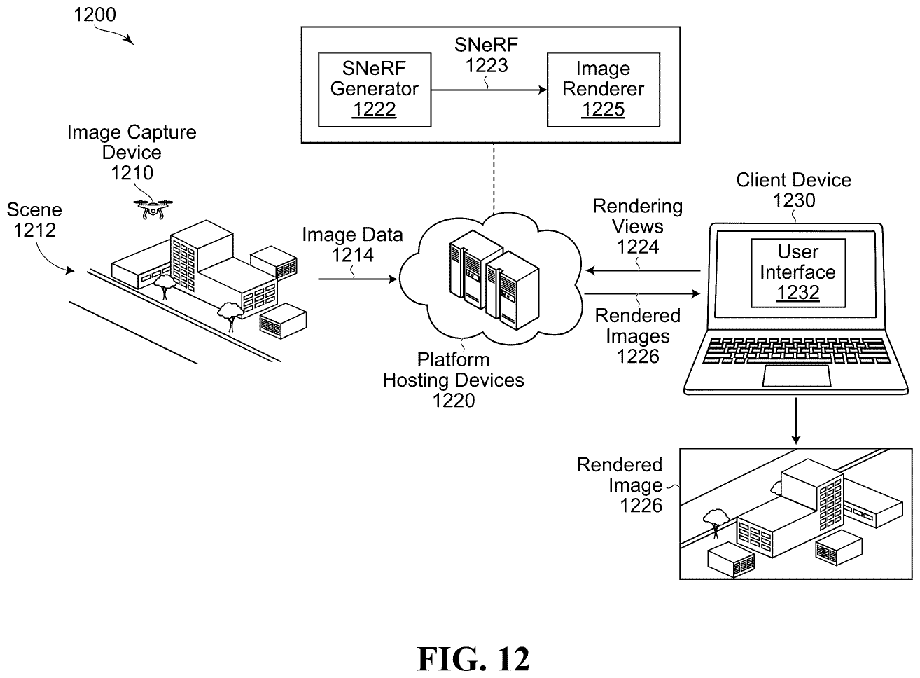

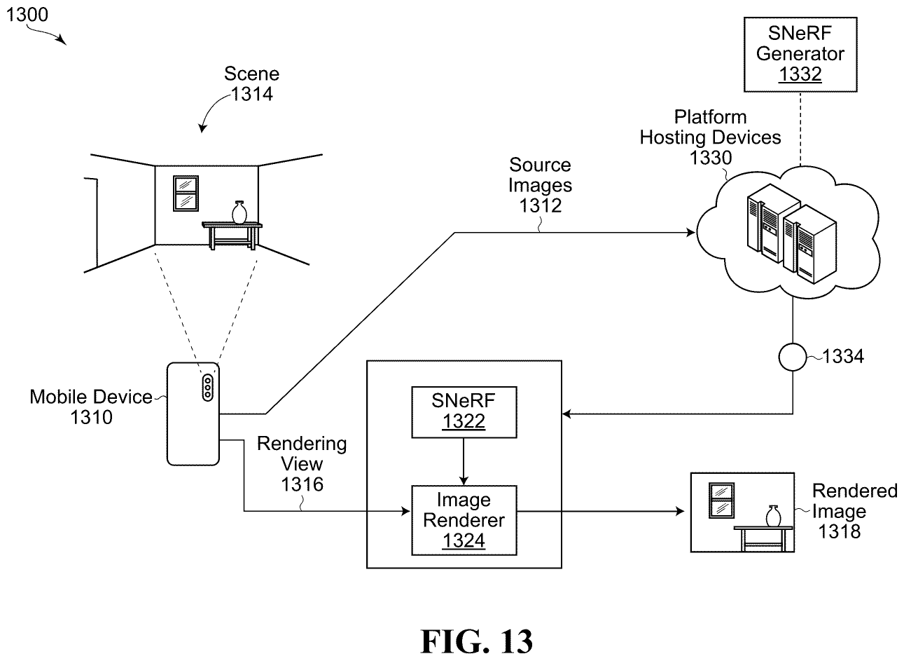

Furthermore, a sparse neural radiance field may be made accessible to end users in a variety of ways, including through a centralized server system or platform, or as a local copy directly on a user device. The following figures FIG. 12 and FIG. 13 present non-limiting example implementations of these use cases.

FIG. 12 is a schematic diagram of an example system 1200 in which a sparse neural radiance field is made available to end users through a centralized server and/or platform. The system 1200 includes one or more image capture devices 1210 to capture image data 1214 of a scene 1212. In the present example, the scene 1212 is depicted as an outdoor scene containing a group of buildings, trees, and roads. The image capture devices 1210 may include any suitable sensor (e.g., camera) onboard a satellite, aircraft, drone, observation balloon, or other device capable of capturing imagery of the scene 1212 (e.g., smartphone). In the present example, the image capture device 1210 is depicted as a drone capturing images of the scene 1212 from several overhead points of view.

The image data 1214 may comprise the raw image data captured by such image capture devices 1210 along with any relevant metadata, including camera parameters (e.g., focal length, lens distortion, camera pose, resolution), geospatial projection information (e.g., latitude and longitude position), or other relevant metadata. The image data 1214 may contain one or several batches of imagery covering the area, which may have been captured on the same dates or on different dates.

The system 1200 further includes one or more platform hosting devices 1220 to process the image data 1214 as described herein to generate rendered images 1226. The platform hosting devices 1220 include one or more computing devices, such as virtual machines or servers in a cloud computing environment comprising one or more processors for executing computing instructions. In addition to processing capabilities, the platform hosting devices 1220 include one or more communication interfaces to receive/obtain/access the image data 1214 and to output/transmit rendered images 1226 through one or more computing networks and/or telecommunications networks such as the internet. Such computing devices further include memory (i.e., non-transitory machine-readable storage media) to store programming instructions that embody the functionality described herein.

The platform hosting devices 1220 are configured to run (i.e., store, host or access) a sparse neural radiance field generator 1222, which represents one or more programs, software modules, or other set of non-transitory machine-readable instructions, configured to process the image data 1214 to generate a sparse neural radiance field 1223, as described herein. The sparse neural radiance field generator 1222 may be similar to the sparse neural radiance field generator 210 of FIG. 2, or any suitable variation thereof, capable of generating the sparse neural radiance field generator 1222 based on the image data 1214. The platform hosting devices 1220 store and hosts the sparse neural radiance field 1223 to be accessed for image rendering purposes.

The platform hosting devices 1220 are also configured to run (i.e., store, host or access) an image renderer 1225, which represents one or more programs, software modules, or other set of non-transitory machine-readable instructions, configured to receive requests for rendering views 1224 and to query the sparse neural radiance field 1223 to generate rendered images 1226, as described herein. The image renderer 1225 may be similar to the image renderer 710 of FIG. 7, or any suitable variation thereof, capable of rendering images based on the sparse neural radiance field 1223. The image renderer 1225 may be capable of receiving requests for rendered views 1224 from one or more client devices 1230, and in turn delivering such rendered images 1226 to the client devices 1230 in response to such requests. The image renderer 1225 may be made accessible through an Application Programming Interface (API) or through a user interface accessible through a web browser, mobile application, or other means.

A client device 1230 may include one or more computing devices configured to run (i.e., store, host or access) one or more software programs to display, process, or otherwise use the rendered images 1226 (e.g., an API or user interface provided by platform hosting devices 1220). A client device 1230 may include a display device that displays a user interface 1232 through which a user may view the rendered images 1226.

In operation, the platform hosting devices 1220 may train the sparse neural radiance field generator 1222 and image renderer 1225 end-to-end on a large dataset of imagery comprising a wide range of scenes captured by one or more image capture devices 1210. After training, the platform hosting devices 1220 may service requests for rendered images 1226 of those scenes. In some cases, the platform hosting devices 1220 may also receive new batches of source images from the image capture devices 1210, or even the client devices 1230, depicting new scenes, and may service requests to render novel views of those scenes as well. The platform hosting devices 1220 may thereby be continually trained on new scenes as new source imagery is contributed.

Although the centralized model described in FIG. 12 above may offer particularly powerful computational resources and training capability (e.g., in a cloud computing environment), in some cases, a more distributed approach may be desired. For example, a scaled-down version of a sparse neural radiance field may be deployed on a smaller-scale user device, as shown in FIG. 13, below.

FIG. 13 is a schematic diagram of an example system 1300 in which a sparse neural radiance field is made available to end users directly through the end users' local devices. The system 1300 includes a mobile device 1310 and one or more platform hosting devices 1330.

The mobile device 1310 may include any suitable device capable of capturing imagery, and with appropriate memory, processing, and communication capabilities (e.g., smartphone, tablet, laptop computer, or other smart device) to perform the functionality described herein.

The mobile device 1310 is configured to store a sparse neural radiance field 1322 transmitted to the mobile device 1310 as a data package 1334 by platform hosting devices 1330. Further, the mobile device 1310 is also configured to run an image renderer 1324, which may be similar to the image renderer 710 of FIG. 7, to generate a rendered image 1318 based on a rendering view 1316 with reference to the sparse neural radiance field 1322.

The mobile device 1310 may also run a software program with a user interface through which a user may capture source images 1312 of the scene 1314 and define rendering views 1316 to be processed by the image renderer 1324.

The platform hosting devices 1330 are configured to run a sparse neural radiance field generator 1332, which may be similar to the sparse neural radiance field generator 210 of FIG. 2, to generate a sparse neural radiance field 1322 based on a set of source images 1312. The platform hosting devices 1330 may also be configured to package the sparse neural radiance field 1322 as a data package 1334 for delivery to the mobile device 1310.

In operation, a user of the mobile device 1310 captures a set of source images 1312 of the scene 1314. The set of source images 1312 may be sparse but should provide sufficient coverage of the scene 1314 to enable novel view synthesis. The mobile device 1310 then transmits these source images 1312 to the platform hosting devices 1330 for processing. At the platform hosting devices 1330, the sparse neural radiance field generator 1332 generates the sparse neural radiance field 1322 and transmits it to the mobile device 1310 as data package 1334. The user of the mobile device 1310 then defines a rendering view 1316 (e.g., by user input through a user interface) and executes the image renderer 1324 to render the rendered image 1318 based on the rendering view 1316, drawing on the relevant feature information stored in the copy of the sparse neural radiance field 1322 stored locally. Since the rendered image 1318 can be rendered based on the feature information stored directly in the sparse neural radiance field 1322, the image rendering process may require relatively little processing resources and can be enabled in real-time.

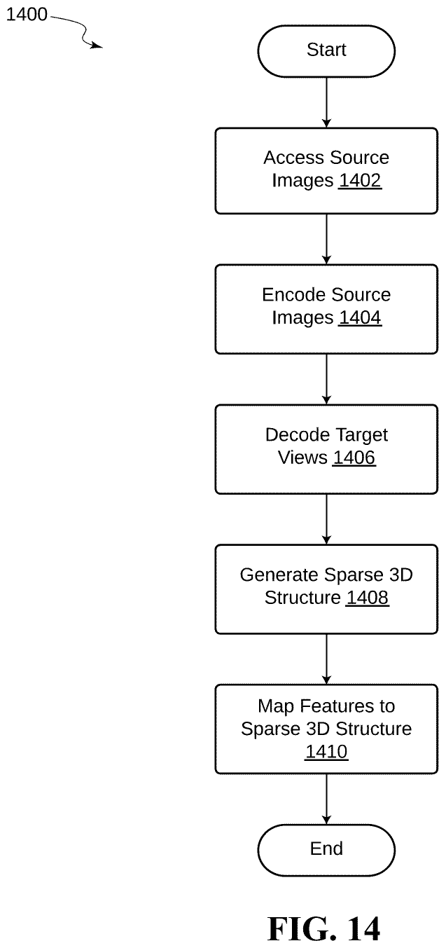

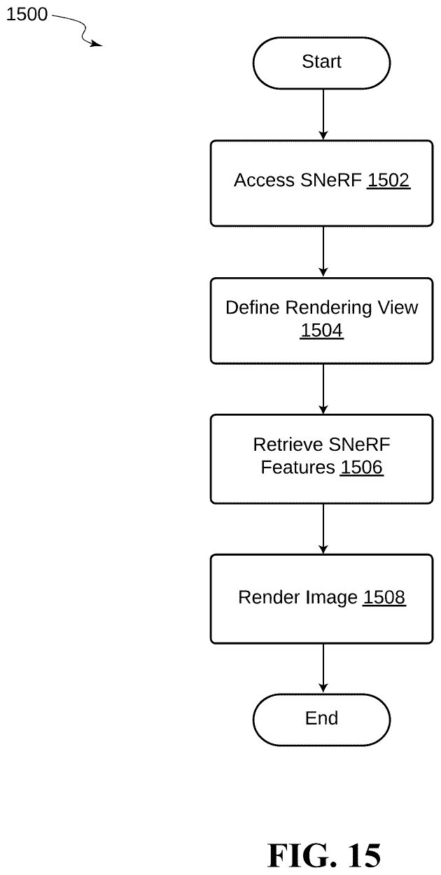

The following figures FIG. 14 and FIG. 15 present non-limiting example methods that summarize the techniques disclosed herein.

FIG. 14 is a flowchart of an example method 1400 for generating a sparse neural radiance field that summarizes the techniques described above. The step of method 1400 may be organized into one or more functional processes and embodied in non-transitory machine-readable programming instructions executable by one or more processors in any suitable configuration, including the computing devices of the systems described here.

The method 1400 involves, at step 1402, accessing a set of source images of a scene, and at step 1404, encoding each source image into a series of multiscale feature maps. The encoding process may comprise applying a series of convolutional layers to each source image. A set of target views of the scene are defined, and at step 1406, each target view is decoded into a series of multiscale feature maps, of corresponding scale, based on the series of multiscale feature maps into which the source images were encoded. At step 1408, a sparse three-dimensional representation of the scene is generated based on the series of multiscale feature maps decoded from the target views. At step 1410, the features of the series of multiscale feature maps decoded from the target views are mapped to the sparse three-dimensional representation of the scene, thereby forming the sparse neural radiance field.

The decoding process may involve applying attention across the features of the multiscale feature maps into which the source images were encoded. More specifically, the decoding process may involve applying a series of cross-attention layers, that attend to layers of features encoded by the encoding process, in addition to applying a series of convolutional layers, to fuse together multiscale features, between attention layers. The attention layers may involve a combination of global attention layers and local attention layers, in which the global attention layers are applied across the high-level features of the multiscale feature maps into which the source images were encoded, and local attention layers are applied across the intermediate and low-level features of the multiscale feature maps into which the source images were encoded. The local attention process may involve generating a depth map for the scene based on the target view for determining a limited set of features of the multiscale feature maps into which the source images were encoded to be included in a local attention calculation.

The sparse three-dimensional representation of the scene may be generated based on the decoded feature maps. This may involve compiling the depth maps generated for the target views into a point cloud and transforming the point cloud into the sparse three-dimensional representation of the scene. The sparse three-dimensional representation of the scene may comprise an octree representation of the scene.

In an octree representation of the scene, the multiscale feature information generated at the decoder may be mapped to the octree representation of the scene in a multiscale fashion. In other words, the high-level feature information may be mapped to the high-level cells of the octree representation, and the low-level feature information may be mapped to the low-level cells of the octree representation. The cells of the octree structure may substantially match at least some of the scales of the decoded feature maps, and the features of the decoded feature maps may be mapped to the cells of the octree of the matching scale.

The features may be mapped to the sparse three-dimensional representation of the scene in accordance with a learned process. This learned process may be trained based on image loss based on images rendered using the sparse neural radiance field. The learned process may determine the relative contribution (i.e., weight) of each of the features of the multiscale feature maps decoded from the target views for each part (i.e., a cell, partition) of the sparse three-dimensional representation of the scene. The mapping process may involve an attention process in which a representation of a part of the sparse three-dimensional representation of the scene (i.e., a cell, partition) is progressively decoded through a series of attention layers that apply attention over the features of the multiscale feature maps decoded from the target views. The progressive decoding may involve applying a series of local attention layers. Applying such a local attention layer may involve projecting a point representing a part of the sparse three-dimensional representation of the scene to the image plane of a target view, and selecting the features in an area surrounding the location to which the point was projected to be included in the local attention calculation.

FIG. 15 is a flowchart of an example method 1500 for real-time image rendering via a sparse neural radiance field that summarizes the techniques described above. The method 1500 may be organized into one or more functional processes and embodied in non-transitory machine-readable programming instructions executable by one or more processors in any suitable configuration, including the computing devices of the systems described here.

The method 1500 involves, at step 1502, accessing a sparse neural radiance field representation of a scene, and at step 1504, defining a rendering view from which an image is to be rendered. At step 1506, a set of features from a set of parts (i.e., cells, partitions) of the sparse neural radiance field that are to be used to render the image are retrieved. At step 1508, the image is rendered based on the features retrieved from the sparse neural radiance field.

Retrieving the set of cells of the sparse radiance field to be used to render the image may involve determining parts of the sparse neural radiance field that are directly captured in the rendering view as well as determining parts of the sparse neural radiance field that are in close proximity to the parts of the sparse neural radiance field that are directly captured in the rendering view. Determining the parts of the sparse neural radiance field to be used to render the image based on the rendering view may also involve applying a learned process to progressively decode a representation of the rendering view through a series of attention mechanisms. Determining the parts of the sparse neural radiance field to be used to render the image further may also involve generating one or more depth maps to aid in the decoding process.

Predicting the depth map for the scene corresponding to the rendering view may be based on the neural features contained in the sparse neural radiance field. Generating such a depth map may involve progressively decoding a representation of the rendering view through a series of attention layers that apply attention over the features of the multiscale feature maps mapped to the sparse three-dimensional representation of the scene. Applying attention may involve applying a series of local attention layers to a representation of the rendering view to progressively decode a set of depth maps for the scene to aid in the image rendering process.

Rendering the image based on the neural features retrieved from the sparse neural radiance field may involve, for each pixel of the image to be rendered, determining a view-dependent radiance for the pixel based on the retrieved features contained in a corresponding part of the sparse neural radiance field.

Finally, it should be recognized that features and aspects of the various examples provided above can be combined into further examples that also fall within the scope of the present disclosure. The scope of the claims should not be limited by the above examples but should be given the broadest interpretation consistent with the description as a whole.

1-72. (canceled)

73. A method for generating a sparse neural radiance field, the method comprising:
accessing a set of source images of a scene;
encoding each source image into a series of multiscale feature maps;
defining a set of target views of the scene;
decoding each target view into a series of multiscale feature maps based on the series of multiscale feature maps into which the source images were encoded;
generating a sparse three-dimensional representation of the scene; and
mapping the features of the series of multiscale feature maps decoded from the target views to the sparse three-dimensional representation of the scene.

74. The method of claim 73, wherein decoding a target view into a series of multiscale feature maps comprises:
applying attention across the features of the multiscale feature maps into which the source images were encoded.

75. The method of claim 74, wherein applying attention across the features of the multiscale feature maps into which the source images were encoded comprises:
applying global attention across high-level features of the multiscale feature maps into which the source images were encoded; and
applying local attention across a limited set of low-level features of the multiscale feature maps into which the source images were encoded.

76. The method of claim 75, wherein applying local attention across the limited set of low-level features of the multiscale feature maps into which the source images were encoded comprises:
generating a depth map for the scene based on the target view; and
determining a limited set of features of the multiscale feature maps into which the source images were encoded to be included in a local attention calculation based on the depth map.

77. The method of claim 76, wherein the sparse three-dimensional representation of the scene is generated based on the series of multiscale feature maps decoded from the target views, by:
compiling the depth maps generated for the target views into a point cloud; and
transforming the point cloud into the sparse three-dimensional representation of the scene.

78. The method of claim 77, wherein mapping the series of multiscale feature maps decoded from the target views to the sparse three-dimensional representation of the scene comprises:
applying a learned process that involves determining relative contributions of the features mapped to the sparse three-dimensional representation of the scene.

79. The method of claim 78, wherein applying a learned process that involves determining relative contributions for the features mapped to the sparse three-dimensional representation of the scene comprises:
progressively decoding a representation of a part of the sparse three-dimensional representation of the scene through a series of attention layers that apply attention over the features of the multiscale feature maps decoded from the target views.

80. The method of claim 79, wherein progressively decoding a representation of a part of the sparse three-dimensional representation of the scene through a series of attention layers that apply attention over the features of the multiscale feature maps decoded from the target views comprises:
applying a series of local attention layers, wherein applying a local attention layer involves:
projecting a point within a part of the sparse three-dimensional representation of the scene to an image plane of a target view;
selecting the features in an area surrounding a location to which the point was projected to be included in a local attention calculation; and
performing the local attention calculation to determine the relative contributions of the features mapped to the sparse three-dimensional representation of the scene.

81. The method of claim 73, wherein the sparse three-dimensional representation of the scene comprises an octree representation of the scene, wherein the octree representation comprises a cellular structure at multiple scales in which cells are recursively divided along surface structures of the scene, and wherein the multiscale feature maps decoded from the target views are mapped to cells of the octree representation of corresponding scale.

82. A method for rendering an image of a scene using a sparse neural radiance field, the method comprising:
accessing a sparse neural radiance field representation of a scene, wherein the sparse neural radiance field comprises a sparse three-dimensional representation of the scene to which multiple scales of feature information have been mapped;
defining a rendering view corresponding to an image to be rendered;
determining parts of the sparse neural radiance field to be used to render the image based on the rendering view; and
rendering the image based on at least one scale of the feature information mapped to the parts of the neural radiance field that are to be used to render the image.

83. The method of claim 82, wherein determining the parts of the sparse neural radiance field to be used to render the image based on the rendering view comprises:
determining parts of the sparse neural radiance field that are directly captured in the rendering view; and
determining parts of the sparse neural radiance field that are in close proximity to the parts of the sparse neural radiance field that are directly captured in the rendering view.

84. The method of claim 82, wherein determining the parts of the sparse neural radiance field to be used to render the image based on the rendering view comprises applying a learned process to progressively decode a representation of the rendering view through a series of attention mechanisms.

85. The method of claim 84, wherein determining the parts of the sparse neural radiance field to be used to render the image further comprises generating one or more depth maps to aid in the decoding.

86. A method comprising:
generating a sparse neural radiance field representation of a scene by decoding feature information for a set of decoded images of the scene based on feature information encoded from a set of source images of the scene and mapping the feature information from the set of decoded images to a sparse three-dimensional representation of the scene; and
rendering an image of the scene based on the feature information mapped to the sparse three-dimensional representation of the scene.

87. The method of claim 86, further comprising:
generating the sparse three-dimensional representation of the scene by compiling point cloud data derived from depth maps that were generated based on at least some of the feature information that is to be mapped to the sparse three-dimensional representation of the scene and transforming the point cloud data into an octree representation that captures surface structures of the scene.

88. The method of claim 87, wherein the octree representation of the scene represents surface structures of the scene at multiple scales, wherein the feature information to be mapped comprises multiscale feature information, and wherein higher-level feature information of the multiscale feature information is mapped to higher-level cells of the octree representation, and lower-level feature information of the multiscale feature information is mapped to lower-level cells of the octree representation.

89. The method of claim 84, wherein mapping the feature to the sparse three-dimensional representation of the scene is a learned process trained on image loss based on images rendered using the sparse neural radiance field.
